(19) United States
(12) Patent Application Publication
(10) Pub. No.: US 2003/0189728 A1
(43) Pub. Date: Oct. 9, 2003

(54) Image forming apparatus

(75) Inventor: Sun-Hae Jung, Yongin-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/404,039

(22) Filed: Apr. 2, 2003

(30) Foreign Application Priority Data
Apr. 9, 2002 (KR) 2002-19301

(51) Int. Cl. H04N 1/405

(52) U.S. Cl. 358/3.06; 358/3.23

(57) ABSTRACT

An image forming apparatus having a plurality of halftone tables to store a toner quantity value corresponding to a displacement of a gradation grade value of a pixel of image data in different patterns, respectively. The image forming apparatus also has a controller to output print image information by selecting any one of the halftone tables and by fetching a toner quantity value corresponding to a gradation grade value of each pixel of original image data in the selected halftone table, and an engine to print an image corresponding the print image information as output in the controller in recording media. Therefore, it is possible to enhance quality of the print image by extending a range of gradation representation in a desired region according to the characteristics of the printed image.

### CROSS-REFERENCE TO RELATED APPLICATION

This application claims the benefit of Korean Application No. 2002-19301, filed Apr. 9, 2002, in the Korean Intellectual Property Office, the disclosure of which is incorporated herein by reference.

### BACKGROUND OF THE INVENTION

1. Field of the Invention

The present invention relates to an image forming apparatus, and more specifically, to an image forming apparatus having a plurality of halftone tables to store different pattern data to thereby enhance quality of an image to be printed.

2. Description of the Prior Art

An image forming apparatus is an apparatus to print and process an image corresponding to original image data to be input in recording media such as printing paper. Examples of the image forming apparatus are printers, copiers or facsimile machines.

In the case of printing the image in an image forming apparatus, a halftone type can be used. In indicating the density of contrast between light and shade by grades, the halftone type represents the grades of the contrast according to the number of dots displayed in one halftone cell, using a lattice-shape halftone cell comprising a number of dots. That is, although the image is not a continuous tone gradation such as printed papers in full color, it seems as if the image is the continuous image rather than a constitution of a number of dots at a certain distance.

The above-mentioned halftone type is used because ink (or toner) used in an image forming apparatus is not variable in density like a light of a computer monitor, but only printed on printing paper according to a command. An image forming apparatus cannot output the dot/spot to be printed in various densities of ink, but it can indicate the dot/spot only in three colors (CMY), or black and white.

An image forming apparatus is used to indicate the original image data displayed on a computer monitor screen. For this purpose, in case of a yellow pixel indicated with the 50% density on the monitor screen, a mode of filling a half of the dot/spot to be printed with yellow ink and leaving the other half unfilled is used. In the same manner, to indicate a yellow pixel with the 25% density, a mode of filling a quarter of the dot/spot to be printed with yellow ink is used.

In a computer monitor, it is common to subdivide and represent a pixel in 256 gradation grades. Similarly, to represent the pixel on printing paper, the dot/spot to be printed needs to be divided in 256 smaller regions. To divide the pixel in the 256 smaller regions, it needs to consist of 16 horizontal spaces and 16 vertical spaces.

A halftone cell is an assembly of a group of dots, which consists of horizontally and vertically regular sized spaces and is lattice-shaped. The halftone cell is a basic unit to determine a density unit in printed papers. Thus, the gradation representation in the printed papers is dependent on how many dots are imprinted within the halftone cell. A very small region where the dots are imprinted in the halftone cell is preferable so that the boundary between the place imprinted with dots and the other empty place is not distinct.

FIG. 1 is a block diagram roughly illustrating a conventional image forming apparatus using a halftone type.

An image forming apparatus comprises a controller 10, an engine 20, an input 30 and an indicator 40, the controller 10 having an interface 11, a halftoning processor 12 and a halftone table 13.

The interface 11 in the controller 10 interfaces original image data input from an external device (not shown). As the external device, a computer or scanner can be used, in which a driver for an image forming apparatus is set.

The controller 10 processes an image of the original image data inputted, controls a print in the engine 20 and controls the whole image forming apparatus.

The engine 20 enables the image to be output under control of the controller 10 to be printed on printing paper. The engine 20 has different structures according to the printing processes, such as an inkjet process, an electro photography process and a thermo electronic process.

The input 30 receives an input of a command to select and operate a menu relating to an operation of the image forming apparatus by a user. The indicator 40 externally indicates the information such as the operational state and mode of the image forming apparatus for notifying the user of the same.

An outputting method by a halftone uses the halftone table 13 built in the corresponding engine 20 to obtain an optimal image. The halftone table 13 in the controller 10 stores a standard gradation grade value (or density value) and a toner quantity value corresponding to a displacement increase of the standard gradation grade value. The toner quantity value means the number of dots eventually imprinted in one halftone cell and it is the density value of the toner as output.

The halftoning processor 12 fetches the toner quantity value corresponding to the gradation grade value of the pixel of input original image data in reference to the halftone table, configures the print image information, and transfers the information to the engine 20. The engine 20 prints the image corresponding to the print image information.

The data stored in the halftone table 13 is implemented as a method of increasing a quantity of toner to be output generally in proportion to the standard gradation grade value or density value. The data is made in a graph as illustrated in FIG. 2, which makes a linear proportional graph.

In the graph, with the X-axis indicating a maximum density value of the image data ranging from 0 to 100, a density value of the corresponding toner, that is, the corresponding toner value is indicated by the Y-axis. The maximum density value 100 corresponds to the gradation grade value 255 in the case of the image data subdivided in the 256 gradation grades, in which the halftone cell is filled with all dots. The minimum density value 0 corresponds to the gradation grade value 0 of the image data subdivided in the 256 gradation grades, in which there is no dot to fill the halftone cell.

However, when using the halftone table having the data patter in the form of the linear proportional value mentioned above, there may occur the case that the gradation representation of the printed image may not be sufficient for the characteristics of the image to be output. For example, there is the case of printing a very bright image emphasizing a highlight region or a very dark image emphasizing a shadow region. In this case, since the range of the gradation representation of the corresponding portion is not wide, the difference of the gradation representation is not recognizable by sight. Since the range of the gradation representation with respect to the region to be emphasized is not wide, there is the problem of making it impossible to notice the difference of the gradation representation even if the number of dots imprinted in the halftone cell were proportionally increased or decreased.

### SUMMARY OF THE INVENTION

Accordingly, it is an object of the present invention to provide an image forming apparatus to enhance quality of an image to be printed by extending a range of a gradation representation in the region that a user desires according to characteristics of the image to be output.

Additional objects and advantages of the invention will be set forth in part in the description which follows and, in part, will be obvious from the description, or may be learned by practice of the invention.

The foregoing and other objects of the present invention are achieved by providing an image forming apparatus comprising: a plurality of halftone tables to store a standard gradation grade value and a toner quantity value corresponding to displacement of the standard gradation grade value in their respectively different patterns; a controller to output print image information generated by selecting any one of a plurality of halftone tables and by fetching the corresponding toner quantity value from the selected halftone table with respect to the gradation grade value of each pixel of original image data inputted; and an engine to print, in recording media, an image corresponding to the print image information as provided from the controller.

In an aspect of the invention, the controller comprises: a memory to store a plurality of halftone tables; and a halftoning processor to print the print image information which is generated by selecting any one of a plurality of halftone tables and fetching the toner quantity value corresponding to the selected halftone table with respect to the gradation grade value of each pixel of the original image data.

The standard gradation grade value and the toner quantity value, which is proportionately increased corresponding to the displacement increase of the standard gradation grade value, are stored in any one of a plurality of halftone tables.

The standard gradation grade value and the toner quantity value are stored in any one of a plurality of halftone tables so as to be nonlinearly increased corresponding to the displacement increase of the standard gradation grade value.

More specifically, it is possible to store the toner quantity value such that an increased quantity ratio of the toner quantity value is gradually increased or decreased corresponding to the displacement increase of the standard gradation grade value.

Furthermore, if the increased quantity ratio of the toner quantity value is gradually increased corresponding to the displacement increase of the standard gradation grade value, and if the standard gradation grade value is larger than a constant value, it is possible to store this information so that the increased quantity ratio of the toner quantity is gradually decreased.

In addition, if the increased quantity ratio of the toner quantity value is gradually decreased corresponding to the displacement increase of the standard gradation grade value and if the standard gradation grade value is bigger than the constant value, it is also possible to store this information so that the increased quantity ratio of the toner quantity is gradually increased.

In the external device to provide the original image data, it is an aspect of the invention to control this data so that any one of a plurality of halftone tables is selected.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a block diagram illustrating a conventional image forming apparatus;

FIG. 2 is a graph illustrating a data pattern stored in halftone tables in the conventional image forming apparatus;

FIG. 3 is a block diagram illustrating an image forming apparatus according to an embodiment of the present invention;

FIG. 4 is a graph illustrating a first data pattern stored in a halftone table in the image forming apparatus illustrated in FIG. 3;

FIG. 5 is a graph illustrating a second data pattern stored in another halftone table in the image forming apparatus illustrated in FIG. 3;

FIG. 6 is a graph illustrating a third data pattern stored in another halftone table in the image forming apparatus illustrated in FIG. 3; and

FIG. 7 is a graph illustrating a fourth data patter stored in the other halftone table in the image forming apparatus illustrated in FIG. 3.

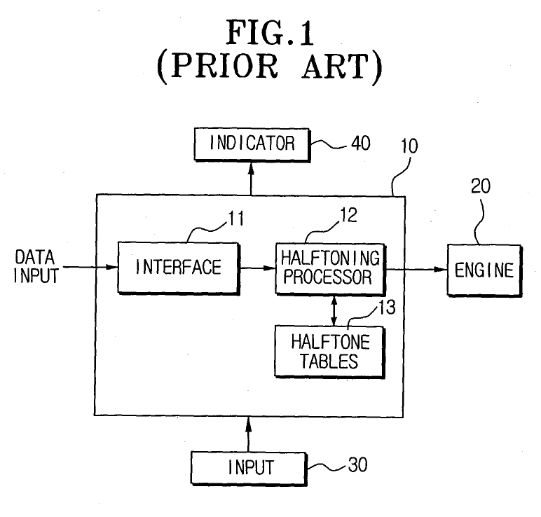

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

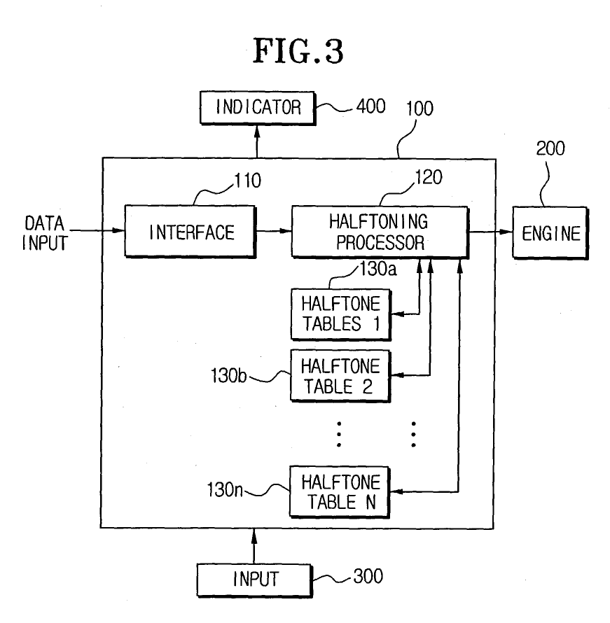

FIG. 3 is a block diagram illustrating an image forming apparatus according to an embodiment of the present invention.

An image forming apparatus comprises a controller 100, an engine 200, an input 300 and an indicator 400. The controller 100 comprises an interface 110, a halftoning processor 120 and a plurality of halftone tables 131a˜130n.

The interface 110 in the controller 100 interfaces original image data inputted from an external device. Examples of an external device (not illustrated) may include, but are not limited to, a computer in which a driver for the image forming apparatus is setup, a scanner, a digital camera or a device enabling to output other original image data.

The controller 100 processes an image of the original image data inputted, controls a printing operation in the engine 200, and controls the whole image forming apparatus.

The engine 200 enables the image to be output under control of the controller 100 to be printed on printing paper. The engine 200 has different structures according to the printing processes such as an inkjet process, an electro photographic process and a thermo electronic process. For example, the electro photographic process is used to process the image through each of several operations, such as electrical charging, exposure, development, transfer, fusing, cleaning and discharging with respect to a drum surface. In this case, the engine 200 is provided with a paper feeding cassette or a feeder to manually feeding paper (not illustrated); an optical portion (not illustrated) to form a latent image by scanning a laser beam on the drum surface; a developing portion (not illustrated) to visualize the drum latent image on printing paper; and a fixing portion (not illustrated) to fix the toner power to the printing paper so that the toner will not depart from the paper.

The input 300 receives an input of a command to select and operate a menu relating to an operation of the image forming apparatus by a user. The indicator 400 externally indicates the information such as the operational state and mode of the image forming apparatus to notify the user of the same.

In the controller 100, a plurality of halftone tables 130a˜130n are set. The halftone tables 130a˜130n store a standard gradation grade value (or density value) of a pixel of image data and the number of dots imprinted in one halftone cell correspond to a displacement increase of the standard gradation grade value. The number of the dots imprinted in the one halftone cell is a toner quantity value to be output. In other words, it is a density value of the toner. A data proportion between the standard gradation grade value and the toner quantity value stored in a plurality of halftone tables 130a˜130n varies in each of the halftone tables 130a˜130n.

The halftoning processor 120 configures print image information by selecting any one of a plurality of halftone tables 130a˜130n and fetching a toner quantity value corresponding to a gradation grade value of a pixel of original image data inputted. The print image information includes an output image corresponding to the image data inputted and the number of dots imprinted in each halftone cell configuring the output image, that is, the toner quantity. The print image information configured by the halftoning processor 120 is transferred to the engine 200 and the engine 200 prints the image corresponding to the print image information on printing paper.

Although the drawings illustrate only the interface 110, the halftoning processor 120 and a plurality of halftone tables 130a˜130n in the controller 100, the controller 100 may be additionally provided with a font storage (not illustrated) to store various fonts to be printed, a memory (not illustrated) to store the input image data before processing, and a central process unit (not illustrated) to analyze and process other character codes and control commands.

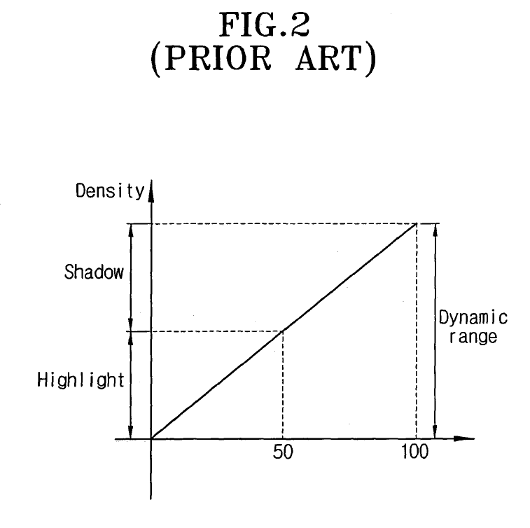

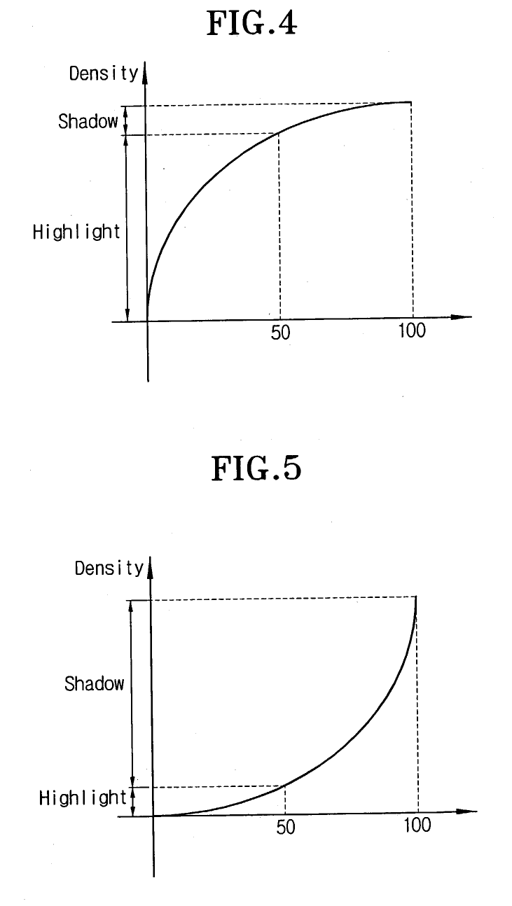

FIGS. 4 to 7 are graphs illustrating proportions of the standard gradation grade values and the toner quantity values, which are stored in each of a plurality of halftone tables 130a˜130n. FIG. 2 illustrates the linearly proportional relation, while FIGS. 4 to 7 illustrate that the nonlinearly proportional relation of the standard gradation grade value vs. the toner quantity value nonlinearly increases. In the graphs, the X-axis represents the displacement of the density value of the pixel of the image data or the standard gradation grade value, and the Y-axis represents the corresponding toner quantity value, or corresponding toner density value.

The data pattern having the linear proportional relation in FIG. 2 is stored in one of a plurality of halftone tables 130a˜130n, and any one of the data patterns of FIGS. 4 to 7 is stored in other halftone tables 130a˜130n.

In FIG. 4, a range of the gradation representation of the highlight region is wide while that of the shadow region is relatively narrow. That is, if the gradation grade value (or density value) of the pixel of the image data is increased, the increase rate of the corresponding toner quantity is gradually decreased. This kind of data pattern enables the broad gradation representation in the highlight region, and therefore, it can be effectively used to output an image of-a white object with a bright background.

FIG. 5 illustrates the case where a range of the gradation representation of the shadow region is wide while that of the highlight region is relatively narrow. That is, if the gradation grade value of the pixel of the image data is increased, the increase rate of the corresponding toner quantity increases accordingly. In this case, it is possible to represent a broad gradation of the shadow region, and it is effectively used to represent a black object with a dark background.

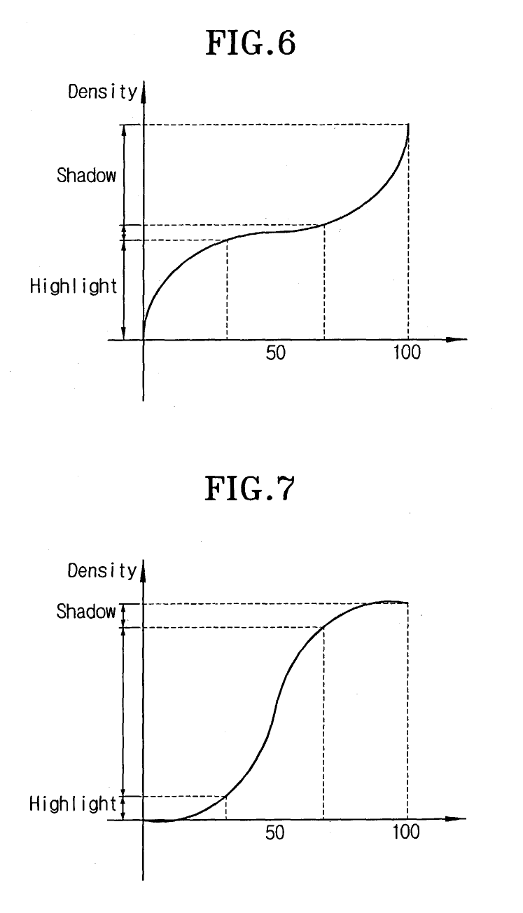

FIG. 6 illustrates the case where a range of the gradation representation in all of the shadow region and the highlight region is wide while a range of the gradation representation in the middle region is relatively narrow. That is, if the gradation grade value of the pixel of the image data is increased, the increase rate of the corresponding toner quantity is gradually decreased in the beginning, and then after passing the median value of the gradation grade value, the increase rate of the toner quantity is gradually increase d. In this case, it is possible to represent a broad gradation in the highlight portion and the shadow portion.

FIG. 7 illustrates the case where a range of the gradation representation in the middle region is wide while a range of the gradation representation in the shadow region and the highlight region is relatively narrow. That is, if the gradation grade value of the pixel of the image data is increased, the increase rate of the corresponding toner quantity is gradually increased in the beginning and then after passing the median value of the gradation grade value, the increase value of the toner quantity is gradually decreased. In this case, it is possible to represent a broad gradation in the middle portion, which is contrary to the case of FIG. 6.

As described above, if an image is output by applying one of the halftone tables 130a˜130n storing each of different data patterns according to the characteristics of the image to be output in the image forming apparatus, a broad gradation in a desired region can be represented. As a result, it is possible to improve the quality of the printed image.

A selection of one of the halftone tables 130a˜130n chosen by the halftoning processor 120 depends on modes to be selected by a user. Namely, the user can select the above-described option (Normal, Highlight, Shadow, Highlight & Shadow, Midtone), by adding a multi-halftone table selection item into the driver of the image forming apparatus installed in the computer being the external device. In addition, a mode to be selected in the input 300 by the user can be used. Namely, the user selects one in the multi-halftone table selection menu provided in the input 300.

The option selected through the driver or input 300 by the user is transferred to the halftoning processor 120, and the halftoning processor 120 selects one of the halftone tables 130a˜130n to be used for the halftone process accordingly.

According to the present invention as described above, the gradation representation of the original image data is processed by referring to one of the halftone tables having different ranges with respect to the gradation representation by the characteristics of the image to be output. This enables enhancement of the quality of the image as printed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus comprising:
a plurality of halftone tables each to store a standard gradation grade value and a toner quantity value corresponding to a displacement of the standard gradation grade value in different patterns, respectively;
a controller to output a print image information generated by selecting any one of the halftone tables and fetching a corresponding toner quantity value in the selected halftone table with respect to a gradation grade value of each pixel of original image data as input; and
an engine to print a corresponding image to the print image information provided from the controller.

2. The image forming apparatus according to claim 1, wherein the controller comprises:
a memory to store the plurality of halftone tables; and
a halftoning processor to output the print image information generated by selecting any one of the halftone tables and fetching the corresponding toner quantity value in the selected halftone table with respect to the gradation grade value of each pixel of the original image data.

3. The image forming apparatus according to claim 1, wherein the standard gradation grade value and the toner quantity value, which is proportionally increased corresponding to an increase of the displacement of the standard gradation grade value, are stored in any one of the halftone tables.

4. The image forming apparatus according to claim 1, wherein the standard gradation grade value and the toner quantity value, which is nonlinearly increased corresponding to the increase of the displacement of the standard gradation grade value, are stored in any one of the halftone tables.

5. The image forming apparatus according to claim 4, wherein the increased quantity ratio of the toner quantity value is stored to be gradually increased corresponding to the increase of the displacement of the standard gradation grade value.

6. The image forming apparatus according to claim 4, wherein the increased quantity ratio of the toner quantity value is stored to be gradually decreased corresponding to the increase of the displacement of the standard gradation grade value.

7. The image forming apparatus according to claim 4, wherein if the increased quantity ratio of the toner quantity value is gradually increased corresponding to the increase of the displacement of the standard gradation grade value, the increased quantity ratio of the toner quantity value is stored to be gradually decreased when the standard gradation grade value is bigger than a constant value.

8. The image forming apparatus according to claim 4, wherein if the increased quantity ratio of the toner quantity value is gradually decreased corresponding to the increase of the displacement of the standard gradation grade value, the increased quantity ratio of the toner quantity value is stored to be gradually increased when the standard gradation grade value is bigger than the constant value.

9. The image forming apparatus according to claim 1, wherein any one of the halftone tables is controlled to be selected in an external device providing the original image data.

10. A method of enhancing the quality of an image to be printed comprising:
providing halftone tables each to store a standard gradation grade value and a toner quantity value corresponding to a displacement of the standard gradation grade value in different patterns, respectively;
outputting print image information generated by selecting any one of the halftone tables provided and fetching a corresponding toner quantity value in the selected halftone table with respect to a gradation grade value of each pixel of original image data as input; and
printing an image corresponding to the print image information output.

11. The method according to claim 10, further comprising:
storing the plurality of halftone tables; and
outputting the print image information generated by selecting any one of the halftone tables and fetching the corresponding toner quantity value in the selected halftone table with respect to the gradation grade value of each pixel of the original image data.

12. The method according to claim 10, further comprising:
storing the standard gradation grade value and the toner quantity value, which is proportionally increased corresponding to an increase of the displacement of the standard gradation grade value, in any one of the halftone tables.

13. The method according to claim 10, further comprising:
storing the standard gradation grade value and the toner quantity value, which is nonlinearly increased corresponding to the increase of the displacement of the standard gradation grade value, in any one of the halftone tables.

14. The method according to claim 13, further comprising:
storing the increased quantity ratio of the toner quantity value to be gradually increased corresponding to the increase of the displacement of the standard gradation grade value.

15. The method according to claim 13, further comprising:
storing the increased quantity ratio of the toner quantity value to be gradually decreased corresponding to the increase of the displacement of the standard gradation grade value.

16. The method according to claim 13, further comprising:
storing the increased quantity ratio of the toner quantity value to be gradually decreased when the standard gradation grade value is bigger than a constant value, if the increased quantity ratio of the toner quantity value is gradually increased corresponding to the increase of the displacement of the standard gradation grade value.

17. The method according to claim 13, further comprising:
storing the increased quantity ratio of the toner quantity value to be gradually decreased when the standard gradation grade value is bigger than a constant value, if the increased quantity ratio of the toner quantity value is gradually decreased corresponding to the increase of the displacement of the standard gradation grade value.

18. The method according to claim 10, further comprising:
controlling any one of the halftone tables to be selected in an external device providing the original image data.
